(19) United States
(12) Patent Application Publication
(10) Pub. No.: US 2019/0227148 A1
(43) Pub. Date: Jul. 25, 2019

(54) OPTICAL SET-UP FOR A LIDAR SYSTEM, LIDAR SYSTEM, AND OPERATING DEVICE

(71) Applicant: ROBERT BOSCH GMBH, Stuttgart (DE)

(72) Inventors: Annette FREDERIKSEN, Renningen (DE); Frank KAESTNER, Bietigheim-Bissingen (DE); Joern OSTRINSKY, Ditzingen (DE); Klaus STOPPEL, Mundelsheim (DE); Reiner SCHNITZER, Reutlingen (DE)

(73) Assignee: Robert Bosch GmbH, Stuttgart (DE)

(21) Appl. No.: 16/318,520

(22) PCT Filed: Jul. 6, 2017
(86) PCT No.: PCT/EP2017/066953

§ 371 Date: Feb. 11, 2019

(30) Foreign Application Priority Data
Jul. 21, 2016 (DE) 10 2016 213 348.9

(51) Int. Cl. G01S 7/481; G01S 17/93; G01S 17/89

(52) U.S. Cl. CPC G01S 7/4816; G01S 7/4814; G01S 17/89; G01S 17/936

(57) ABSTRACT

An optical set-up for a LiDAR system for the optical detection of a field of view, in particular for an operating device or for a vehicle, including an optical receiver system configured in segmented fashion having a—particularly uneven—plurality of optically projecting segments, in which the optically projecting segments of the optical receiver system are situated side by side.

### FIELD OF THE INVENTION

The present invention relates to an optical set-up for a LiDAR system, a LiDAR system as well as an operating device. The present invention relates in particular to an optical set-up for a LiDAR system for the optical detection of a field of view, in particular for an operating device, a vehicle or the like. The present invention furthermore relates to a LiDAR system for the optical detection of a field of view as such and in particular for an operating device, a vehicle or the like. The present invention furthermore creates a vehicle.

### BACKGROUND INFORMATION

When using operating devices, vehicles and other machines and equipment, operating assistance systems or sensor systems for detecting the operational surroundings are increasingly utilized. Apart from radar-based systems or systems on the basis of ultrasound, light-based detection systems are also increasingly used, e.g. so-called LiDAR (light detection and ranging) systems.

LiDAR systems have a disadvantage in that in order to achieve a high accuracy when scanning the field of view, the required large receive or input aperture of the LiDAR system can conventionally only be achieved by a corresponding structural size for developing the optical set-up including the optical receive system. This reduces the flexibility of the application of LiDAR systems.

### SUMMARY OF THE INVENTION

By contrast, the optical set-up of the present invention having the features described herein has the advantage that in spite of a large aperture on the receiver side the optical set-up is able to be situated in a flexible manner having a reduced overall height or overall width. The present invention having the features described herein achieves this by creating an optical set-up for a LiDAR system for the optical detection of a field of view, in particular for an operating device, a vehicle or the like, having an optical receiver system configured in segmented fashion having a—particularly uneven—plurality of optically projecting segments, in which the optically projecting segments of the optical receiver system are situated side by side. Because of (i) the segmented configuration of the optical receiver system having a plurality of optically projecting segments and (ii) the ability to situate the segments of the optical receiver system side by side, it becomes possible, depending on the structural conditions of the application, to situate the plurality of the optically projecting segments of the optical receiver system in a suitably distributed manner so that the installation space may be likewise distributed accordingly.

The further descriptions herein indicate exemplary embodiments of the present invention.

For situating the segments of the optical receiver system, there are various geometrical possibilities for adapting to the respective case of application.

One advantageous development of the optical set-up provides for the optically projecting segments of the optical receiver system to be situated
in a direction perpendicular to a receiving direction of the optical receiver system,
in a direction perpendicular to a direction of a beam path of the optical receiver system,
along a—which may be straight—line and/or
horizontally and/or vertically adjacent to one another relative to an orientation of the underlying LiDAR system or the underlying operating machine.

All measures may be combined with one another as desired and may be supplemented by additional measures if indicated, in particular in order to achieve a reduced structural height, e.g. having a comparatively flat laterally elongated structural shape, in comparison to a conventional and non-segmented configuration. Instead, it is also possible to use the measures possible in accordance with the present invention to reduce a lateral extension of the optical set-up of the LiDAR system in order to obtain a horizontally narrow and vertically more extended structure. With the approach of the present invention it is thus possible to achieve a narrow or flat structural shape for the optical set-up with a LiDAR, whose orientation in space is determined by the choice of segmentation and the side by side arrangement.

The indications “vertical” and “horizontal” refer to the geometry of a reference system of the respective case of application and in particular to the orientation of a gravitational field, e.g. that of the earth.

The optical set-up is particularly advantageous in the interaction of the optical receiver system with a detector device.

Thus an advantageous specific embodiment of the optical set-up of the present invention provides for the optical receiver system to be configured for the optical projection of the field of view on a provided detector device.

Accordingly, it is of particular advantage, if each segment of the optical receiver system is configured for the optical projection of an associated segment of the field of view onto the detector device. This measure achieves an association between the optically projecting segments of the optical receiver system and the segments of the field of view.

A particularly accurate detection of the field of view to be scanned is achieved if according to another development of the optical set-up of the present invention the totality of all segments of the field of view, associated with the optically projecting segments of the optical receiver system, cover the field of view as a whole.

Particularly favorable projection conditions are achieved with a view to a good utilization of the available segments of the optical receiver system, if according to another development of the optical set-up of the invention the segments of the field of view associated with the optically projecting segments of the optical receiver system have no overlap or have an overlap of less than 10%, which may be of less than 5%, further particularly of less than 2% of the respectively covered solid angle.

A vanishing overlap is best suited for a minimal system. In order to support and configuration an adjustment more precisely, however, an overlap may also be advantageous. The measure of the overlap, of course, should be selected to be as small as possible and as large as necessary.

It is in particular conceivable that a segmentation having only two elements is performed. In this case, a greater overlap may be desired. For precisely the direction below 0° with respect to the optical axis would be at the edge of the two segments. Optical systems usually have an inferior quality of projection at the edge, e.g. because of vignetting, etc. This is equivalent to a reduced range. It is possible to counteract this state in that e.g. the overlapping region is configured to be somewhat greater so that this important area of the field of view is detected twice.

A particularly compact optical set-up may be achieved in that segments associated with the optically projecting segments of the optical receiver system are directly adjacent to one another, in particular so as to be adjoining.

Alternatively, it is possible that the segments of the field of view associated with the optically projecting segments of the optical receiver system are spaced apart from one another. In this manner it is possible to achieve a spatially distributed type of construction that may be adapted to the respective cases of application.

As was explained above in detail, an essential aspect of the present invention is the concept of segmentation and re-arrangement, in this case of the optical receiver system.

The concept of segmentation may alternatively or additionally also be applied to the configuration of the detector device.

Thus another specific embodiment of the optical set-up provides for the detector device to be configured in segmented fashion having a plurality of detector segments and for there to exist in particular a 1-to-1 correspondence between the optically projecting segments of the optical receiver system and the detector segments and/or for the detector segments to have a spatial arrangement corresponding to the spatial arrangement of the optically projecting segments of the optical receiver system.

A possible correspondence of the spatial arrangement shall be understood above and below e.g. as an identical orientation of the arrangement, e.g. horizontal, vertical or any other direction.

Furthermore, it is conceivable to apply the concept of the segmentation and distributed arrangement alternatively or additionally to a or the optical transmitter system of the optical set-up of the present invention.

Thus it is of particular advantage if the optical set-up of the present invention is configured to have an optical transmitter system configured in segmented fashion having a plurality of optical segments for illuminating the field of view with light, in particular using a split beam path, in which there exists a 1-to-1 correspondence between the optically projecting segments of the optical receiver system and the optical segments of the optical transmitter system and/or in which the optical segments of the optical transmitter system have a spatial arrangement corresponding to the spatial arrangement of the optically projecting segments of the optical receiver system.

In this connection, the point is in particular that the transmit-side segmentation agrees with the receive-side segmentation. This may be the case in certain specific embodiments, but it is not necessarily so.

Alternatively, it would be possible that on the transmit side e.g. the entire field of view is illuminated by a beam deflected by a micromirror and that there is a segmentation only on the receive side.

Light is to be understood here as including, apart from electromagnetic radiation in the range that is visible for humans, also IR radiation, e.g.—but not exclusively—in the range of 905 nm.

The segmentation of the optical transmitter system offers particular advantages in application in that for the utilization of the parallax effect an optical segment of the optical transmitter system and an optically projecting segment of the optical receiver system are spaced apart from one another in a direction perpendicular to a transmit and/or receive direction of the optical transmitter system and, respectively, the optical receiver system and/or in a direction perpendicular to a direction of a beam path of the optical receiver system and/or the optical transmitter system.

The present invention furthermore relates to a LiDAR system for the optical detection of a field of view, in particular for an operating device, a vehicle or the like. The LiDAR system of the present invention is developed to have an optical set-up according to the present invention.

According to another aspect of the present invention, an operating device is also created, which is configured as having a LiDAR system according to the present invention, which is used for the optical detection of a field of view.

The operating device according to the present invention may be in particular an operating machine, a vehicle, a robot or another general production or operational facility.

Specific embodiments of the present invention are described in detail with reference to the appended figures.

### BRIEF DESCRIPTION OF THE DRAWINGS

FIG. 1 shows the configuration of a specific embodiment of the LiDAR system of the present invention in a schematic block diagram.

FIG. 2 shows a specific embodiment of an optical set-up of the present invention with a focus on the optical receiver system in a lateral cross-sectional view.

FIGS. 3, 4, 5 and 6 show other specific embodiments of the LiDAR system of the present invention using a specific embodiment of the optical set-up according to the present invention in a schematic and perspective representation.

FIGS. 7 and 8 show in a schematic representation a vertical and, respectively, a horizontal division of a field of view into segments when using a specific embodiment of the optical set-up of the present invention.

FIG. 9 schematically depict aspects of the distance determination by triangulation by utilizing the parallax effect.

### DETAILED DESCRIPTION

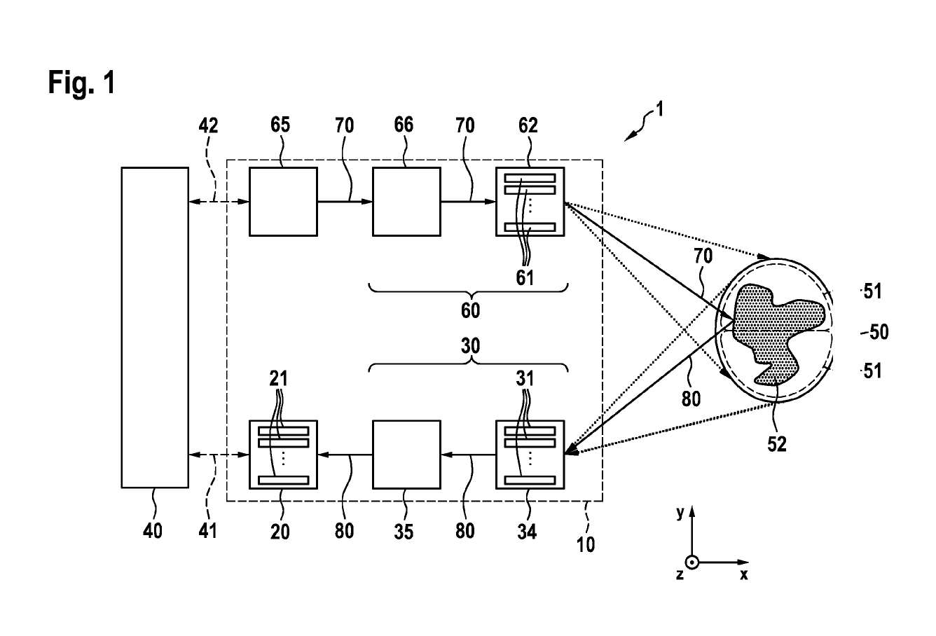

Exemplary embodiments of the present invention are described in detail below with reference to FIGS. 1 through 8. Identical and equivalent elements and components as well as elements and components that act in an identical or equivalent manner are designated with the same reference symbols. The designated elements and components are not described in detail in every case of their occurrence.

The represented features and further characteristics may be isolated from one another in any desired form and may be combined with one another as desired, without departing from the essence of the invention.

In the form of a schematic block diagram, FIG. 1 shows a specific embodiment of LiDAR system 1 of the present invention using a specific embodiment of the optical set-up 10 of the present invention.

LiDAR system 1 according to FIG. 1 has an optical transmitter system 60, which is fed by a light source 65, e.g. in the form of a laser, and emits primary light 70—possibly after passing through a beam-shaping optical system 66—into a field of view 50 for investigating an object 52 located there.

According to FIG. 1, LiDAR system 1 furthermore has an optical receiver system 30, which receives secondary light 80 reflected by object 52 in field of view 50 via an objective 34 as primary optical system and transmits it—possibly via a secondary optical system 35—to a detector device 20.

Light source 65 as well as detector device 20 are controlled via control lines 42 and 41, respectively, using a control and evaluation unit 40.

FIG. 1 shows the concept of the segmentation of the optical components of LiDAR system 1 schematically in three respects, although this is not essential.

For one, optical receiver system 30 has a plurality of optically projecting segments 31 in the area of objective 34, e.g. in the form of a plurality of objective lenses geometrically configured accordingly. Every optically projecting segment 31 has assigned to it a corresponding solid angle range in front of objective 34, which forms a segment 51 of the field of view 50 of LiDAR system 1.

The assignment occurs by orienting the optically projecting segments 31 relative to one another and relative to the desired field of view field 50.

In operation, as a result of this assignment by orientation, a respective optically projecting segment 31 of the optical receiver system 30 projects a segment 51 of field of view 50 onto detector device 50 by receiving secondary light 80.

Field of view segments 51 cover field of view 50 entirely, i.e., the entire field of view 50 is detected in the form of the projected field of view segments 51 by their totality.

Another aspect of the segmentation is found in the specific embodiment shown in FIG. 1 in the LiDAR system 1 of the present invention in the area of optical deflection system 62 of optical transmitter system 60, specifically by providing a plurality of optical segments 61. These may be e.g. a plurality of mirror elements that are controllable independently of one another, and which project primary light 70 onto, and, if indicated, scan, solid angle ranges of the LiDAR system that differ from one another.

A third aspect of the segmentation in the specific embodiment of the LiDAR system 1 as shown in FIG. 1 is implemented in the area of detector device 20 by providing a plurality of detector segments 21.

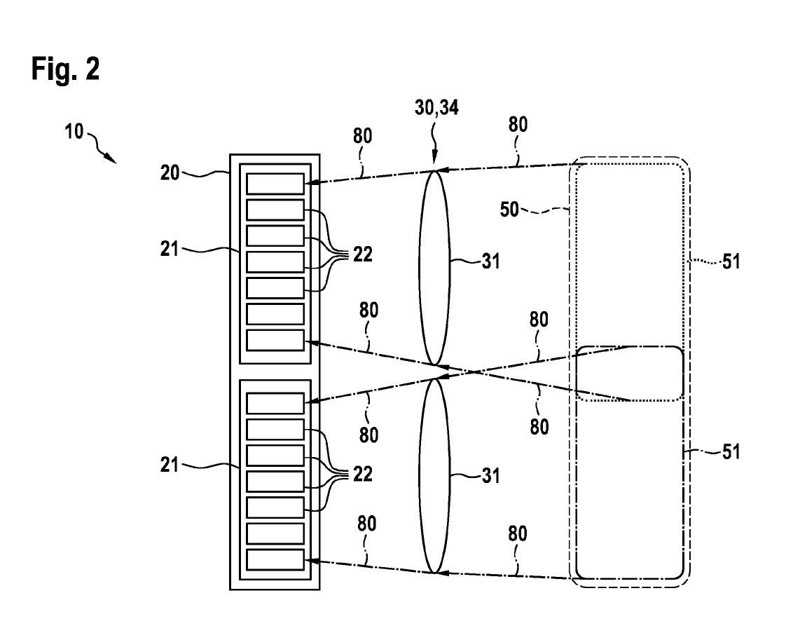

FIG. 2 shows in a schematic and cutaway lateral view a specific embodiment of optical set-up 10 for a LiDAR system 1 with a focus on optical receiver system 30 and detector device 20.

A field of view 50 of LiDAR system 1 is shown having field of view segments 51 that overlap one another and that cover in their combination the entire field of view 50 in the solid angle.

The overlap of the individual field of view segments 51 is not essential and is advantageously only minimal so that no observational gaps arise in the edge region of mutually adjoining field of view segments 51 of field of view 50. As was already mentioned above, an overlap may one the other hand be helpful in certain specific embodiments for compensating for adjustment tolerances.

Each field of view segment 51 is assigned to an optically projecting segment 31 of optical receiver system 30, e.g. in the sense of an objective 34. The assignment is such that by the projection of optically projecting segment 31 of optical receiver system 30 it is precisely the assigned field of view segment 51 that is optically projected onto detector device 20. It is essential in the specific embodiment shown in FIG. 2 that there exists a 1-to-1 correspondence between a respective detector segment 21, an optically projecting segment 31 of optical receiver system 30 and the associated field of view segment 51. This 1-to-1 correspondence is advantageous, but is not essential.

Each detector segment 21 of detector device 20 as shown in FIG. 2 is made up of a plurality of detector elements 22.

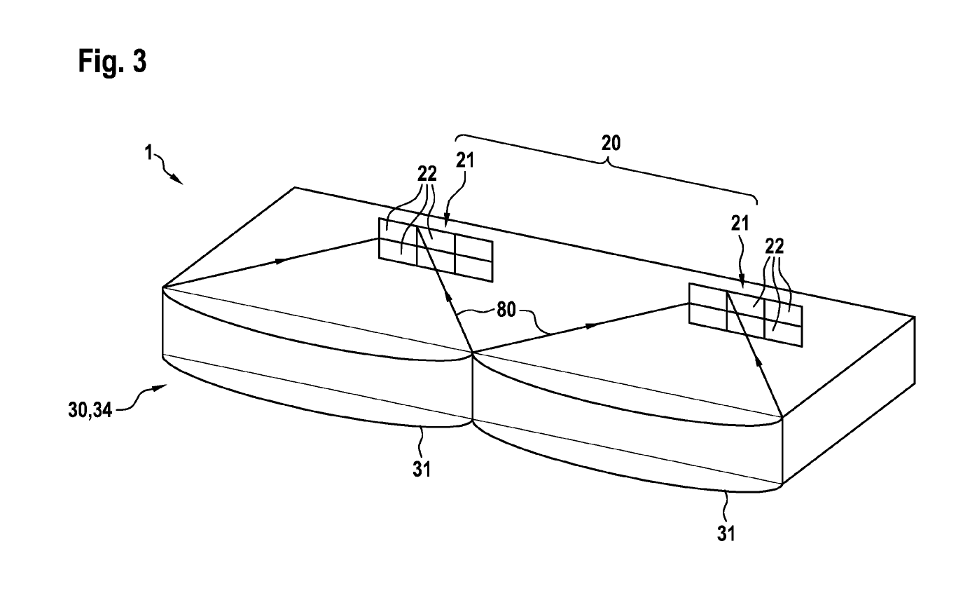

FIG. 3 shows in a schematic and partially perspective view another specific embodiment of the LiDAR system 1 of the present invention having two optically projecting segments 31 of optical receiver system 30 in the form of an objective 34, which respectively project secondary light 80 from field of view 50 onto a respective detector segment 21 of detector device 20 having a plurality of six detector elements 22.

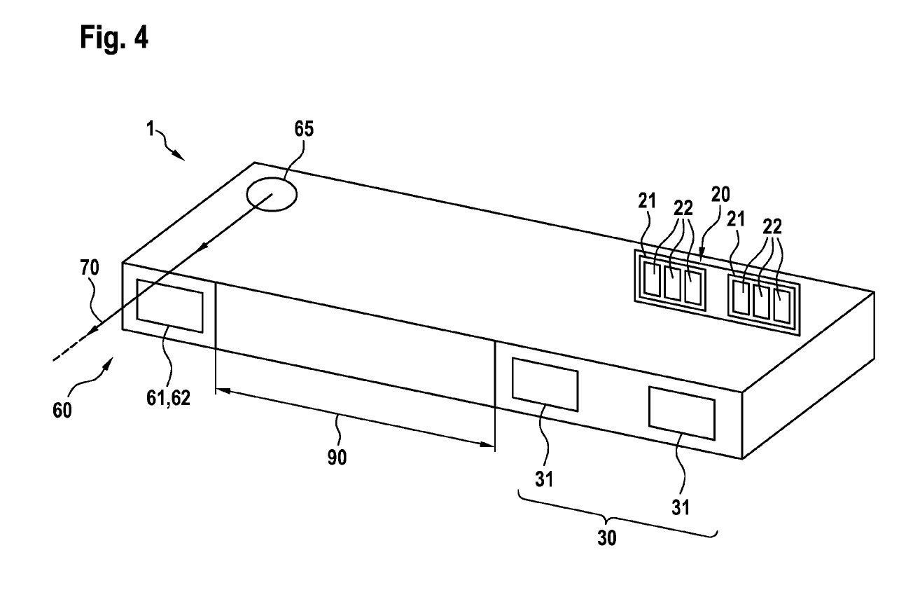

FIG. 4 shows in a schematic and perspective view another specific embodiment of the LiDAR system 1 of the present invention, in which the segmentation in the area of optical receiver system 30 having a plurality of optically projecting segments 31 may be used in connection with optical transmitter system 60 so as to make use of the parallax effect via a distance 90 between an optical segment 61 of optical transmitter system 60, e.g. in the sense of an optical deflection system or a deflection mirror 62, and optical receiver system 30 in order to obtain further information about the geometry of field of view 50 and in particular about a distance of an object 52 contained in field of view 50.

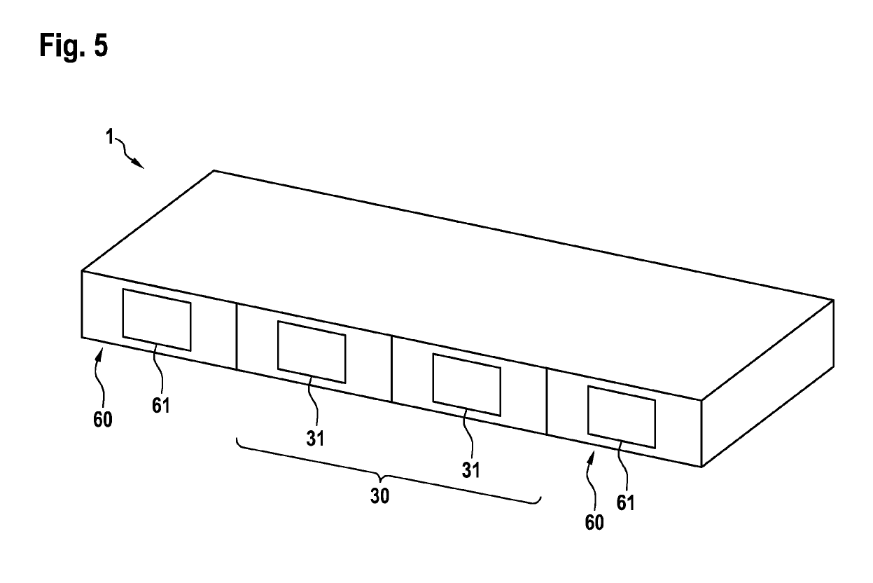

In the specific embodiment of LiDAR system 1 of the invention as shown in FIG. 5, which is shown in a perspective lateral view, optical receiver system 30 and optical transmitter system 60 are developed respectively having two segments 31 and 61.

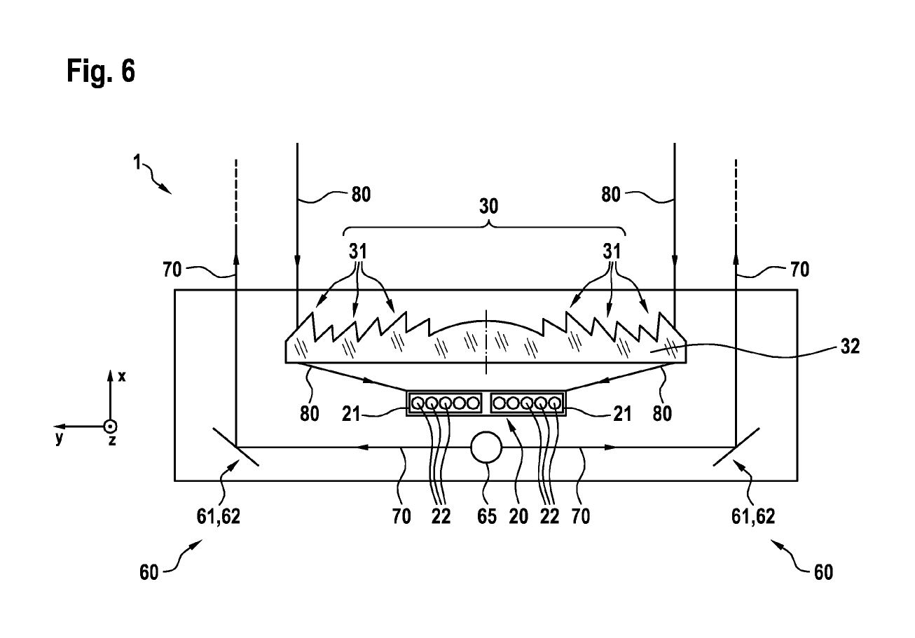

FIG. 6 shows in a schematic and cutaway lateral view another specific embodiment of LiDAR system 1 of the present invention.

In this specific embodiment, a segmentation of optical transmitter system 60 is achieved by providing a pair of spatially separated deflection mirrors 62 as segments 61 of optical transmitter system 60 for emitting the primary light 70.

In the specific embodiment of LiDAR system 1 as shown in FIG. 6, a segmentation of optical receiver system 60 for receiving and projecting secondary light 80 is formed by the faceted optical system of Fresnel lens 32 of optical receiver system 30. Here the individual facets form the segments 31 of the optical receiver system, possibly with a corresponding association of segments 51 of a field of view 50 with the object 52 contained therein.

FIG. 6 shows a single Fresnel lens 32. It may be used e.g. in order to reduce the structural depth of a normal lens. Here it would also be conceivable, however, to provide a faceted optical system, possibly even without Fresnel structure, since Fresnel structures may have disadvantages, specifically at certain angles of observation.

In the specific embodiment shown in FIG. 6, LiDAR system 1 has two detector segments 21 having a plurality of detector elements 22 in detector device 20.

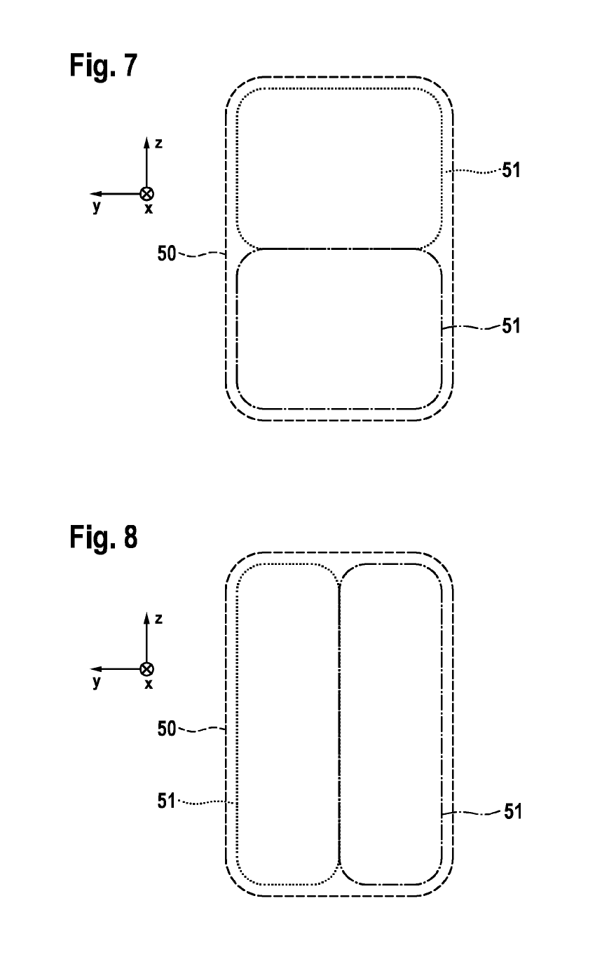

FIGS. 7 and 8 respectively show a vertical and a horizontal segmentation of a field of view 50 with individual field of view segments 51.

In the sense of the present invention, the spatial terms “horizontal,” “vertical” and the like refer to a usual set-up of a LiDAR system 1 in connection with an underlying device, which may be in the gravitational field of the Earth.

These and further features and characteristics of the present invention are elucidated in more detail in the following explanations:

In LiDAR systems, often an objective is used as optical receiver system 30 that has a round aperture in the receive path. Provided detectors 22 of a detector device 20 lie in the projection area of this one objective 34. The entire field of view (FOV) is projected by this objective 34.

In order to collect the greatest possible number of photons, it is advantageous to have a large receive aperture, which results in a large structure in the case of a round lens.

LiDAR sensors are desired, however, in a flat and elongated construction so that they fit e.g. between the ribs of a radiator grille of an automobile.

Moreover, in the conventional construction, heat in the interior cannot be dissipated with sufficient efficacy. A flat construction is able to improve the thermal behavior of a LiDAR system in this regard.

An essential idea of the present invention is the separation of functional elements of optical receiver system 30—e.g. of objective lenses 34—and possibly also of detector chips 21, of laser source 65 and/or of transmit path 60 into at least two elements, which are in particular spatially arranged next to one another and/or one on top of the other so as to yield a flat construction. For this purpose, the previously unified field of view 50 (FoV) may be divided horizontally or vertically, as shown in FIGS. 7 and 8, so as to produce a flat construction of system 1 in the process.

In this approach, it is also possible to separate the lenses of a faceted optical system into individual elements in order to reduce the structural depth. Tilted lens elements are also conceivable so as to transfer one dimension of FOV 50 into others.

The present invention yields the following advantages:
A flat construction is possible.
New installation positions are possible, e.g. between the ribs of a radiator grille of an automobile.
A distributed construction is possible.
It is possible to utilize the parallax effect.

FIG. 3 shows how it is possible by dividing lenses in objective 34 of optical receiver system 30 and detector areas or segments 21 of detector device 20 to ensure an overall uniform receiving surface and at the same time produce a flat construction.

A division of optical receiver system 30 into two or another even number of lenses as segments 31 offers the possibility of situating optical transmitter system 60 between the two or more elements.

It is also possible, however to use an uneven number of lenses—e.g. three—as segments 31 of optical receiver system 30. The advantage of particularly suitable projection properties exists in the middle.

This concept also offers the possibility of situating the transmitting and receiving elements 31 and 61 respectively and/or the individual detector segments 21 or detector elements 22 flexibly, as is indicated in FIGS. 4 and 5.

In a distributed construction as shown in FIG. 4, it is also possible to use the parallax effect in order to obtain further information for determining the distance.

A division of the transmit path including transmitter system 60 is also conceivable and indicated in FIG. 5. Here it is possible to situate optical receiver system 30 in the middle between segments 61 of transmitter system 60 or of the transmit path. In the division of the transmit path, it is possible e.g. to work with two lasers or with one laser that is split before leaving the device.

FIG. 3 shows the division of lenses as optically projecting segments 31 of optical receiver system 30 and of detector surfaces as detector segments 21 of detector device 20 configured to achieve a flat construction while maintaining the same receiving surface.

FIG. 4 shows a distributed construction, in which segments 61 of optical transmitter system 60 and segments 31 of optical receiver system 30 are horizontally pulled apart. For close distances it is possible to use the parallax effect in order to obtain further information regarding the distance.

FIG. 5 shows schematically the flexible arrangement of segments 61 of the optical transmitter system and of segments 31 of the optical receiver system 30.

FIG. 6 shows the division of a laser beam using two micromirrors 62 as segments 61 of optical transmitter system 60 and in between an optical receiver system 30 of the type of a faceted optical system 32 that projects the different field of view areas as segments 51 of field of view 50.

FIGS. 7 and 8 show schematically a possible division of field of view 50 with segments 51 in the horizontal and in the vertical direction.

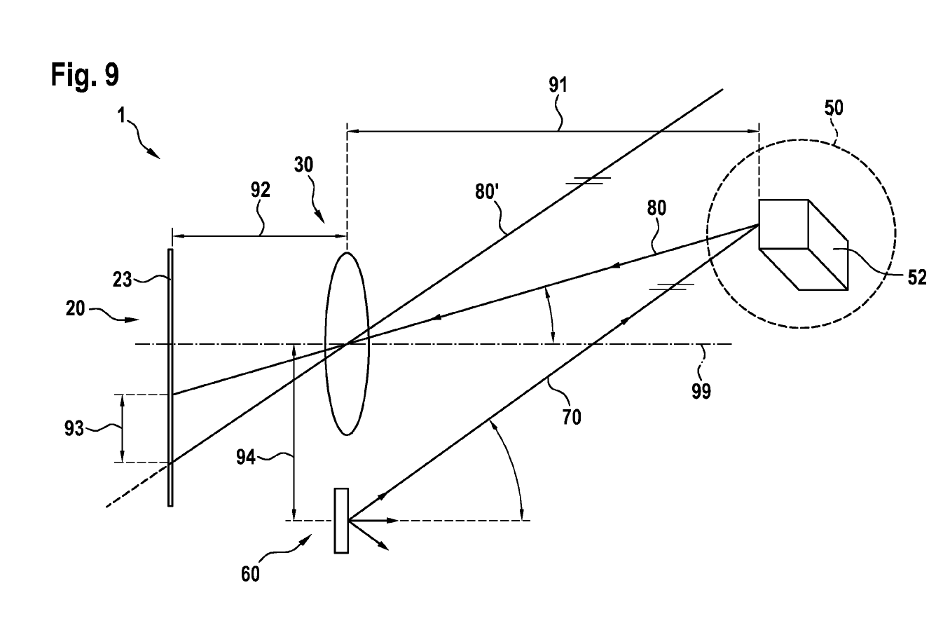

FIG. 9 describes schematically aspects of the distance determination by triangulation by utilizing the parallax effect.

The LiDAR system 1 shown schematically in FIG. 9 is equipped with an optical receiver system 30, an optical transmitter system 60 and a detector device 20 having a detector plane 23. Primary light 70 emitted by optical transmitter system 60 strikes an object 52 in field of view 50, which reflects the received primary light 70 as secondary light 80. Secondary light 80 strikes optical receiver system 30 and is directed by the latter onto detector device 20.

FIG. 9 shows schematically how it is possible on the basis of the basic distance 94 between the optical receiver system and the optical transmitter system 60, which is also indicated by symbol b, in addition to the propagation time measurement, to infer also the distance 91 of object 52 from optical receiver system 30 in connection with the parallax effect by triangulation. This distance is also designated by z. In connection with focal length 92, which is also indicated by symbol f, and distance 93, the following formulaic representation is obtained if this distance is indicated by d in the detector plane 23, which is identical with the focal plane of optical receiver system 30:

$$\frac{b}{d} = \frac{z}{f} ⇔ z = \frac{b \cdot f}{d}$$

1-12. (canceled)

13. An optical set-up for a LiDAR system for providing optical detection of a field of view, for an operating device or for a vehicle, comprising:
an optical receiver system configured in segmented fashion, including a plurality of optically projecting segments;
wherein the optically projecting segments of the optical receiver system are situated next to one another.

14. The optical set-up of claim 13, wherein the optically projecting segments of the optical receiver system are situated:
in a direction perpendicular to a receiving direction of the optical receiver system,
in a direction perpendicular to a direction of a beam path of the optical receiver system, along a line, and
horizontally and/or vertically adjacent to one another relative to an orientation of the underlying LiDAR system or an underlying operating device.

15. The optical set-up of claim 13, further comprising:
a detector device, wherein the optical receiver system is configured for optically projecting the field of view onto the detector device.

16. The optical set-up of claim 13, wherein each segment is configured for optically projecting an associated segment of the field of view onto the detector device.

17. The optical set-up of claim 13, wherein the totality of all segments of the field of view associated with the optically projecting segments of the optical receiver system cover the field of view.

18. The optical set-up of claim 13, wherein segments of the field of view associated with the optically projecting segments of the optical receiver system have no overlap or have an overlap of less than 10% of the respectively covered solid angle.

19. The optical set-up of claim 13, wherein the segments of the field of view associated with the optically projecting segments of the optical receiver system are situated directly adjacent to one another or are spaced apart from one another.

20. The optical set-up of claim 15, wherein the detector device is configured in a segmented manner having a plurality of detector segments, and wherein a 1-to-1 correspondence exists between the optically projecting segments of the optical receiver system and the detector segments and/or the detector segments have a spatial arrangement corresponding to the spatial arrangement of the optically projecting segments of the optical receiver system.

21. The optical set-up of claim 13, further comprising:
an optical transmitter system configured in segmented fashion having a plurality of optical segments for illuminating the field of view with light, in particular by a divided beam path;
wherein a 1-to-1 correspondence exists between the optically projecting segments of the optical receiver system and the optical segments of the optical transmitter system and/or the optical segments of the optical transmitter system have a spatial arrangement corresponding to the spatial arrangement of the optically projecting segments of the optical receiver system.

22. The optical set-up of claim 21, wherein for a use of the parallax effect an optical segment of the optical transmitter system and an optically projecting segment of the optical receiver system are spaced apart from one another in a direction perpendicular to a transmit and/or receive direction of the optical transmitter system and, respectively, the optical receiver system and/or in a direction perpendicular to a direction of a beam path of the optical receiver system and/or the optical transmitter system.

23. A LiDAR system for providing an optical detection of a field of view, for an operating device or for a vehicle, comprising:
an optical set-up for the LiDAR system for providing the optical detection of the field of view, for an operating device or for a vehicle, including:
an optical receiver system configured in segmented fashion, including a plurality of optically projecting segments;
wherein the optically projecting segments of the optical receiver system are situated next to one another.

24. An operating device for a vehicle, comprising:
a LiDAR system for providing an optical detection of a field of view, for an operating device or for a vehicle, including:
an optical set-up for the LiDAR system for providing the optical detection of the field of view, for an operating device or for a vehicle, including:
an optical receiver system configured in segmented fashion, including a plurality of optically projecting segments;
wherein the optically projecting segments of the optical receiver system are situated next to one another.

25. The optical set-up of claim 13, wherein the optical receiver system includes an uneven plurality of optically projecting segments.

26. The optical set-up of claim 13, wherein the optically projecting segments of the optical receiver system are situated:
in a direction perpendicular to a receiving direction of the optical receiver system,
in a direction perpendicular to a direction of a beam path of the optical receiver system, along a straight line, and
horizontally and/or vertically adjacent to one another relative to an orientation of the underlying LiDAR system or an underlying operating device.

27. The optical set-up of claim 13, wherein segments of the field of view associated with the optically projecting segments of the optical receiver system have no overlap or have an overlap of less than 5% of the respectively covered solid angle.

28. The optical set-up of claim 13, wherein segments of the field of view associated with the optically projecting segments of the optical receiver system have no overlap or have an overlap of less than 2% of the respectively covered solid angle.

29. The optical set-up of claim 13, wherein the segments of the field of view associated with the optically projecting segments of the optical receiver system are situated directly adjacent to one another, in particular adjoining to one another, or are spaced apart from one another.
